(19) United States
(12) Patent Application Publication
(10) Pub. No.: US 2005/0018261 A1
(43) Pub. Date: Jan. 27, 2005

(54) Method and device for transferring the wave front of a primary light pulse to a secondary light pulse

(75) Inventors: Dieter Langhans, Elmshorn (DE); Gerd Wollmann, Celle (DE); Ulf Krause, Jena (DE)

Correspondence Address: VENABLE, BAETJER, HOWARD AND CIVILETTI, LLP, P.O. BOX 34385, WASHINGTON, DC, 20043-9998, US

(73) Assignee: Rheinmetall W&M GmbH, Unterluss (DE)

(21) Appl. No.: 10/864,528

(22) Filed: Jun. 10, 2004

(30) Foreign Application Priority Data
Jun. 11, 2003 (DE) 103 26 221.0

(51) Int. Cl. G03H 1/10

(52) U.S. Cl. 359/10

(57) ABSTRACT

The invention relates to a method for transferring the wave front of primary light pulses with a specifiable first pulse duration and/or energy to secondary light pulses with a specifiable second pulse duration and/or energy. For an easy realization of a wave front transformation of this type, it is suggested according to the invention to store respectively in a first time segment the wave fronts of the primary light pulses with the aid of reference light pulses as spatial hologram in a holographic memory. In a following second time interval, this stored, spatial hologram is then read out with the aid of reconstruction light pulses, having the second pulse duration and energy, wherein the reconstruction light pulses for reading out the hologram have the same wavelength and wave front as the reference light pulses.

### CROSS-REFERENCE TO RELATED APPLICATIONS

This application claims the priority of German Patent Application No. 103 26 221.0, filed Jun. 11, 2003, which is incorporated herein by reference.

### FIELD OF THE INVENTION

The invention relates to a method for transferring the wave front of primary light pulses with a specifiable first pulse duration and/or energy to secondary light pulses with a specifiable second pulse duration and/or energy. The invention furthermore relates to a device for realizing a method of this type.

### BACKGROUND OF THE INVENTION

The problem frequently encountered in practical operations is how to realize a wave front transformation of different light pulses with the same or different pulse duration and/or energy. One example of this is the irradiation of distant objects (or targets) with a power laser. Since an irradiation of this type can result in laser beam distortions caused by turbulence, a non-linear optical phase conjugation is carried out for compensating this distortion. However, an efficient, non-linear optical phase conjugation requires intensive light pulses. For that reason, light pulses with a pulse duration in the nanosecond range are primarily used for the phase conjugation. For the interaction between light pulses and the target material, however, it may be advantageous to use pulses in the microsecond or millisecond range. It would therefore be desirable to realize a transformation of phase-conjugated light pulses with a pulse duration in the nanosecond range to obtain corresponding phase-conjugated light pulses with a pulse duration in the microsecond or millisecond range following the transformation.

### SUMMARY OF THE INVENTION

Thus, it is the object of the present invention to specify a method of the aforementioned type, which makes it easy to carry out a wave front transformation of different light pulses, wherein the light pulses can have the same or different pulse duration and/or energy, as well as to provide a device for realizing the method.

This object is solved according to the invention with the features disclosed in the method of the invention and with the features disclosed in the device of the invention. Additional and particularly advantageous modifications of the invention are further disclosed.

The method of invention includes a method for transferring the wave front of primary light pulses with a specifiable first pulse duration and/or energy to secondary light pulses with a specifiable second pulse duration and/or energy. The method comprises: (a) in a first time segment, storing the primary light pulse wave front with the aid of reference light pulses as a spatial hologram in a holographic memory; and (b) in a following, second time segment, reading out the stored spatial hologram with the aid of reconstruction light pulses having the second pulse duration, wherein the reconstruction light pulses for reading out the hologram have the same wavelength and wave front as the reference pulses.

With the method of the invention, the pulse duration of the secondary light pulses is selected to be different from the pulse duration of the primary light pulses.

With the method of the invention, the pulse duration of the secondary light pulses is selected to be longer than the pulse duration of the primary light pulses.

With the method of the invention, the wave front of the primary light pulses is generated such that following the reconstruction of the hologram, the wave front for the secondary light pulses is used to compensate for phase interferences caused by a medium through which the secondary light pulses travel.

With the method of the invention, prior to generating the hologram, the primary light pulses travel through the medium through which the secondary light pulses must travel and which causes phase interferences, a phase conjugation is carried out for the primary light pulses with phase interference, and the phase-conjugated light pulses are then stored as the hologram.

With the method of the invention, for the medium having time-dependent phase interferences, a time for storing and reading out the hologram is selected to be shorter than or the same as a maximum change in an expected phase interference.

With the method of the invention, the energy for the reconstruction light pulses is selected such that the secondary light pulses have a higher energy as compared to the primary light pulses.

The device of the invention includes an optically addressable spatial light modulator, which contains a liquid crystal layer as a light-modulating medium, used as the holographic memory.

With the device of the invention, the holographic memory is arranged inside a device for irradiating a target, in which the phase interferences caused by the atmosphere are compensated. The device comprises a first laser arrangement for generating light pulses with a first pulse duration, as well as a phase conjugation mirror on which the primary light pulses, reflected on the target, are reflected following amplification, such that they interfere as primary light pulses together with reference light pulses on a photo-semiconductor that is assigned to the holographic memory and in turn generate the spatial hologram in the liquid-crystal layer. The device further comprises a second laser arrangement for generating the reconstruction light pulses for reading out the stored hologram from the holographic memory, wherein the reconstruction light pulses have a longer pulse duration than the primary light pulses.

With the device of the invention, a power amplifier is connected downstream of the holographic memory, which amplifies the secondary light pulses to obtain the energy required for subsequent use.

With the device of the invention, the second laser arrangement generates the reconstruction light pulses with a higher energy than the primary light pulses that impinge on the holographic memory.

The invention is essentially based on the idea that the wave fronts of the primary light pulses with a first specified pulse duration and energy are stored during a first time segment with the aid of reference light pulses as spatial hologram in a holographic memory. The stored, spatial hologram is then read out in a following second time segment with the aid of reconstruction light pulses, having a second pulse duration and energy, wherein the reconstruction light pulses for reading out the hologram have the same wavelength and wave front as the reference pulses.

The pulse duration of the primary and secondary light pulses can be the same or different. For the initially mentioned example, the pulse duration of the phase-conjugated secondary light pulses will be in the microsecond and/or millisecond range and the pulse duration of the phase-conjugated primary light pulses will be in the nanosecond range.

The energy of the primary and secondary light pulses can also be the same or different, wherein for an energy intensification, the energy of the reconstructed phase-conjugated secondary light pulse depends on the destruction threshold of the holographic memory.

In particular, optically addressable spatial light modulators (OASLM) that are commercially available have proven suitable as read-in and read-out memories for the spatial holograms, wherein these are provided with a liquid-crystal layer as light-modulating medium.

### BRIEF DESCRIPTION OF THE DRAWINGS

Further details and advantages of the invention follow from the exemplary embodiments below, which are explained with the aid of Figures and show in:

FIG. 1, which illustrates a schematic arrangement of a holographic memory for the wave front transformation according to the invention of two optical pulses; and

FIG. 2, which illustrates a device according to the invention for irradiating a target.

### DETAILED DESCRIPTION OF THE INVENTION

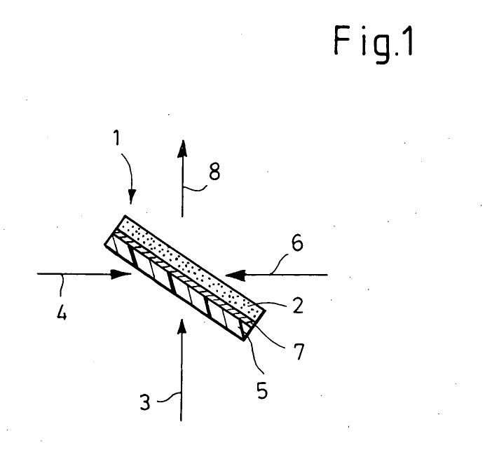

FIG. 1 shows a holographic memory, indicated only schematically, which essentially consists of an optical addressable spatial light modulator that uses a liquid crystal layer 2 for the modulation. Light modulators of this type, which are frequently also called OASLM, are commercially available and are marketed, for example, by the company Jenoptik Laser, Optik Systeme GmbH.

For storing a phase-conjugated primary light pulse 3, this pulse together with a reference light pulse 4 of the same wavelength is written into the holographic memory 1, meaning the phase-conjugated primary light pulse 3 and the reference light pulse 4 are imaged on a photo-semiconductor 5 that is assigned to the liquid crystal layer 2. Thus, an electric hologram is generated through the interference of the light pulses 3 and 4, which leads in the liquid crystal layer 2 to a corresponding spatial distribution of the orientation of the generally nematic crystals and thus to a location-dependent variation of the refractive index for the liquid-crystal layer. In order to generate the hologram, the phase-conjugated primary light pulse 3 and the reference light pulse 4 must hit the photo-semiconductor 5 at different angles of incidence.

For reading out the hologram stored in the liquid crystal layer 2, a reconstruction light pulse 6, e.g. of a different pulse duration and/or energy but with the same wavelength as the reference light pulse 4, is guided toward the liquid crystal layer 2. The reconstruction light pulse travels through this layer and is reflected, e.g. by a reflector 7 that is located between the photo-semiconductor 5 and the liquid crystal layer 2, so that a reconstructed, phase-conjugated secondary light pulse 8 results at the output of the holographic memory 1. It is important for this process that the reference light pulse 4 as well as the reconstruction light pulse 6 have the same wave fronts (as a rule, these are level wave fronts), so that the wave front of the secondary light pulse 8 coincides with the wave front of the phase-conjugated primary pulse 3.

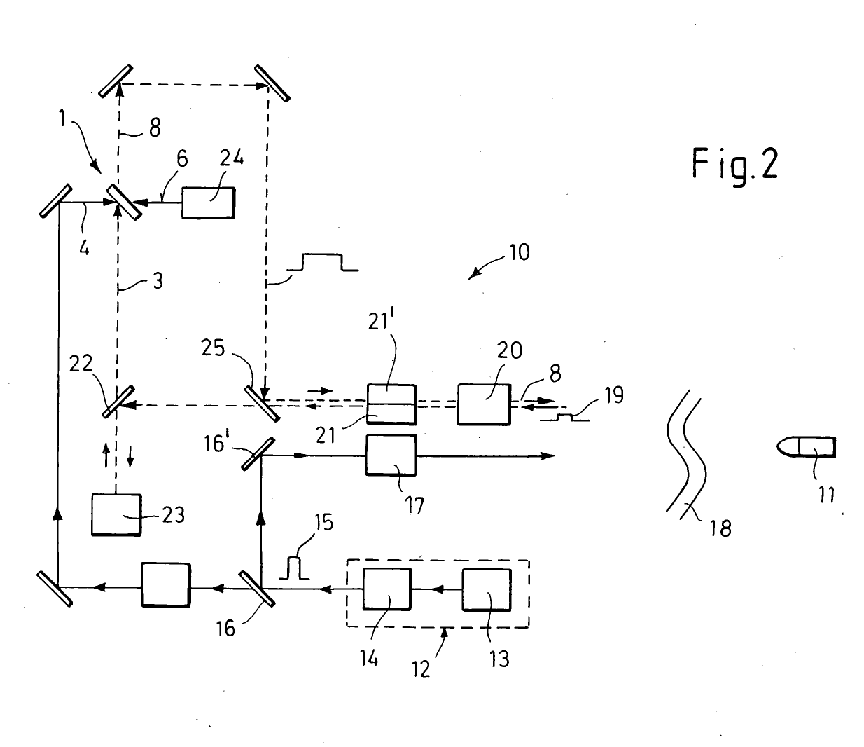

FIG. 2 shows the use of the above-described arrangement with a device 10 according to the invention for irradiating a target 11 with secondary light pulses 8 (preferably with a wavelength in the “near infrared” range), wherein the pulse duration, for example, is in the micro-second range.

The device 10 comprises a first laser arrangement 12, consisting of a continuously-operating laser 13 that is followed by an electro-optical switch 14. The light pulse 15 which is generated with the aid of switch 14 and has a pulse duration of several 10 ns, for example, is deflected via the deflection mirror 16, 16′, travels through a first amplifier 17 of the device 10 and impinges on the target 11 after passing through the schematically indicated atmosphere 18.

The light pulse 19 that is reflected by the target 11 is captured by a telescope optic 20 of the device 10 and is amplified in a second amplifier 21. The amplified light pulse 19 subsequently impinges on a first polarizing beam divider 22 which guides the light pulse 19 onto a phase-conjugation mirror 23. The resulting, phase-conjugated primary light pulse 3 passes the first polarizing beam divider 22, following a suitable polarization rotation (not shown herein), and arrives at the holographic memory 1, previously described in connection with FIG. 1.

There, the primary light pulse 3 interferes with a reference light pulse 4 which is also generated by the first laser arrangement 12 at the appropriate instant (coinciding in time with the phase-conjugated light pulse, taking into account the light transit time) and the amplitude and phase of the primary light pulse 3 are then stored in the holographic memory 1.

Since the phase conjugation causes a frequency displacement, the reference light pulse must also be displaced accordingly (not shown herein).

The reconstruction light pulse 6, arriving from a second laser arrangement 24, impinges on the holographic memory 1 from precisely the same direction as the reference light pulse 4. As a result of the diffraction on the hologram, the phase-conjugated secondary light pulse 8 is reconstructed in the first diffraction order. By means of a suitable polarization and via and a second polarizing beam divider 25, the secondary light pulse 8 is then coupled into a power amplifier 21′ and is directed with the telescope optic 20 toward the target 11.

The above-described device 10 can be used, for example, as medium-energy laser weapon for destroying projectiles 11. With devices of this type, the combination of the non-linear phase conjugation and the use of a holographic memory for the wave front transformation among other things is particularly advantageous for two reasons:

On the one hand, the pulse duration of the secondary light pulse is determined not by the pulse duration of the primary light pulse, but by the pulse duration of the reconstruction light pulse. The pulse duration of the secondary light pulse therefore can be selected so as to effect an efficient interaction between the laser pulse and the target material, wherein the secondary light pulse can be amplified in the downstream connected power amplifier to obtain the energy required for the laser weapon.

Differences in the pulse duration result in incomplete compensation of the phase interference by the atmosphere only if the write-in/read-out cycle of the holographic memory is slower than the turbulence change in the atmosphere. Turbulence changes of this type occur with maximum 100 Hz (corresponding to 10 ms). Since the OASLM, used as holographic memory, permits a write-in/read-out cycle of approximately 0.1 to 1 ms, the device according to the invention can be used for turbulence compensation.

On the other hand, the device 10 has a high sensitivity. Thus, the OASLM used as holographic memory 1 has a sensitivity in the order of magnitude of 10⁻⁴ to 10⁻⁶ J/cm². The second amplifier 21 and the phase-conjugation mirror 23 together show an amplification of up to 10¹⁰. Extremely weak laser pulses of 5×10⁻¹⁴ to 5×10⁻¹⁶ J, which are backscattered by the target 11, can therefore be “read into” a 5 cm² large OASLM 1.

Depending on the destruction threshold of the holographic memory that is used, the reconstructed, phase-conjugated secondary light pulse can generate a 10⁴ energy gain as compared to the “written-in” phase-conjugated primary light pulse.

On the whole, an energy gain of approximately 10¹⁴ of the laser pulse scattered back by the target 11 can be achieved when using a combination of non-linear optical phase conjugation and an OASLM for the holographic memory.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method for transferring the wave front of primary light pulses with a specifiable first pulse duration and/or energy to secondary light pulses with a specifiable second pulse duration and/or energy, said method comprising:
a) in a first time segment, storing the primary light pulse wave front with the aid of reference light pulses as a spatial hologram in a holographic memory; and
b) in a following, second time segment, reading out the stored spatial hologram with the aid of reconstruction light pulses having the second pulse duration, wherein the reconstruction light pulses for reading out the hologram have the same wavelength and wave front as the reference pulses.

2. The method according to claim 1, wherein the pulse duration of the secondary light pulses is selected to be different from the pulse duration of the primary light pulses.

3. The method according to claim 2, wherein the pulse duration of the secondary light pulses is selected to be longer than the pulse duration of the primary light pulses.

4. The method according to claim 1, wherein the wave front of the primary light pulses is generated such that following the reconstruction of the hologram, the wave front for the secondary light pulses is used to compensate for phase interferences caused by a medium through which the secondary light pulses travel.

5. The method according to claim 4, wherein prior to generating the hologram, the primary light pulses travel through the medium through which the secondary light pulses must travel and which causes phase interferences, a phase conjugation is carried out for the primary light pulses with phase interference, and the phase-conjugated light pulses are then stored as the hologram.

6. The method according to claim 5, wherein for the medium having time-dependent phase interferences, a time for storing and reading out the hologram is selected to be shorter than or the same as a maximum change in an expected phase interference.

7. The method according to claim 6, wherein the energy for the reconstruction light pulses is selected such that the secondary light pulses have a higher energy as compared to the primary light pulses.

8. A device according to claim 1, wherein an optically addressable spatial light modulator, which contains a liquid crystal layer as a light-modulating medium, is used as the holographic memory.

9. The device according to claim 8, wherein
the holographic memory is arranged inside a device for irradiating a target, in which the phase interferences caused by the atmosphere are compensated,
the device comprises a first laser arrangement for generating light pulses with a first pulse duration, as well as a phase conjugation mirror on which the primary light pulses, reflected on the target, are reflected following amplification, such that they interfere as primary light pulses together with reference light pulses on a photo-semiconductor that is assigned to the holographic memory and in turn generate the spatial hologram in the liquid-crystal layer,
the device further comprises a second laser arrangement for generating the reconstruction light pulses for reading out the stored hologram from the holographic memory, wherein the reconstruction light pulses have a longer pulse duration than the primary light pulses.

10. The device according to claim 9, wherein a power amplifier is connected downstream of the holographic memory, which amplifies the secondary light pulses to obtain the energy required for subsequent use.

11. The device according to claim 10, wherein the second laser arrangement generates the reconstruction light pulses with a higher energy than the primary light pulses that impinge on the holographic memory.
